(19) United States
(12) Patent Application Publication
(10) Pub. No.: US 2002/0141793 A1
(43) Pub. Date: Oct. 3, 2002

(54) Oil application device and web therefor

(76) Inventors: Kohichi Kimura, Hamamatsu-shi (JP); Tatsuo Takagi, Hamamatsu-shi (JP); Shigeru Nakama, Hamamatsu-shi (JP)

Correspondence Address: NIXON & VANDERHYE P.C., 8th Floor, 1100 North Glebe Road, Arlington, VA, 22201-4714, US

(21) Appl. No.: 10/108,031

(22) Filed: Mar. 29, 2002

(30) Foreign Application Priority Data
Mar. 30, 2001 (JP) P2001-102580
Mar. 28, 2002 (JP) P2002-91404

(51) Int. Cl. G03G 15/20

(52) U.S. Cl. 399/325

(57) ABSTRACT

An oil application device includes a web that comes in contact with the surface of the fuser roller, a supply roll for delivering the web, and a take-up roll for taking up the web, wherein the web is applied and impregnated with a mixture of a fuser oil and a curing agent.

### BACKGROUND OF THE INVENTION

1. Field of the Invention

This invention relates to an oil application device for applying and supplying fuser oil at a toner-fixing portion in an electronic copier or in an electrophotographic printer, and a web therefor.

2. Description of the Related Art

An oil application device in the form of a roll or the like is a constituent part which works to apply fuser oil onto a fuser roller or the like at a toner-fixing portion in an electronic copier or in an electrophotographic printer, in order to prevent the toner from being adhered onto the fuser roller and to prevent the recording paper from being adhered and taken up.

As the oil application device, there has heretofore been known the one in which a welt layer is arranged as an oil transfer layer to surround a porous oil-holding member of a cylindrical shape, and a FTFE porous film on the uppermost surface is arranged as an oil application control layer. For example, Japanese Patent Unexamined Publication Hei. 10-171287 discloses a web-like oil applying member, including a PTFE porous film which absorbs oil and provided on a reinforcing sheet, and a web-like oil applying member, in which oil is absorbed in a unwoven cloth.

However, the PTFE porous film used for the oil application device is expensive, and the cost of the PTFE porous film occupies a large proportion of the cost of the whole oil application device. Therefore, use of the PTFE porous film is becoming a barrier against lowering the cost of the oil application device demanded by a recent trend toward lowering the cost of computer-related equipment. Further, there is a problem in that absorbed oil is leaked

### SUMMARY OF THE INVENTION

In view of such circumstances, this invention provides an oil application device capable of applying oil to a degree equivalent to that of the PTFE porous film without using the PTFE porous film but using a cheap material, and a web therefor.

Under such circumstances, the present inventors have conducted keen study and have discovered the fact that if a paper made of a heat resistant fiber is impregnated with an oil including a silicone oil and a curing agent to thereby form a web, the oil application control performance equivalent to that of using the PTFE porous film can be obtained without using the PTFE porous film, and the present inventors have finished the invention.

A first aspect of the invention is concerned with an oil application device for applying and supplying fuser oil onto a fuser roller, including a web that comes in contact with the surface of the user roller, a supply roll for delivering the web, and a take-up roll for taking up the web, wherein the web is applied and impregnated with a mixture of a fuser oil and a curing agent by having a paper made of a heat resistant fiber impregnated with the same mixture.

A second aspect of the invention is concerned with an oil application device, wherein the fuser oil is a silicone oil, and the curing agent is a silicone varnish or a silicone rubber.

A third aspect of the invention is concerned with an oil application web for applying and supplying fuser oil, wherein the web is applied and impregnated with a mixture of a fuser oil and a curing agent by having a paper impregnated with the same mixture.

A fourth aspect of the invention is concerned with an oil application web, wherein the fuser oil is a silicone oil, and the curing agent is a silicone varnish or a silicone rubber.

In a solution of a mixture of a fuser oil and a curing component, the fuser oil and the curing component are dispersed in each other at a level of the order of submicrons or smaller. When the web is applied and impregnated with the above mixture solution and the curing component is cured, the fuser oil is held in the web in a state of being dispersed at a level of the order of submicrons or smaller. The web is a paper (usually nonwoven fabric) of a heat-resistant fiber having a porous property due to voids among the fibers, and holds the fuser oil as it is dispersed in the voids among the fibers. This can be regarded to be a state where fine porous property is further imparted to the web due to the curing component dispersed in the fuser oil. The fuser oil which is dispersed and held is applied onto the fuser roller from the web as the web comes in contact with the fuser roller.

In this invention, the web is applied and impregnated with a mixture of the fuser oil that is to be applied and the curing component to coat and reinforce the web, to impart more densely porous property to the web and to fill the web with the coating oil. In the web, further, the fuser oil and the curing component are existing with being dispersed in each other. Accordingly, they enable the web to highly hold the fuser oil and suppressing the oil from being undesirably oozed out or leaked. Further, the paper made of a heat-resistant fiber is effective to reduce a manufacturing cost since PTFE film is unnecessary, and it is easy to handle. Further, it offers a merit of easily adjusting the fuser oil-holding factor by adjusting the mixing amount of the fuser oil and the curing agent. Upon selecting the kind of the heat-resistant fiber, further, the web itself exhibits an increased heat resistance.

### BRIEF DESCRIPTION OF THE DRAWING

FIG. 1 is a sectional view illustrating the invention.

DETAILED DESCRIPTION OF THE PREFERRED EMBODIMENTS

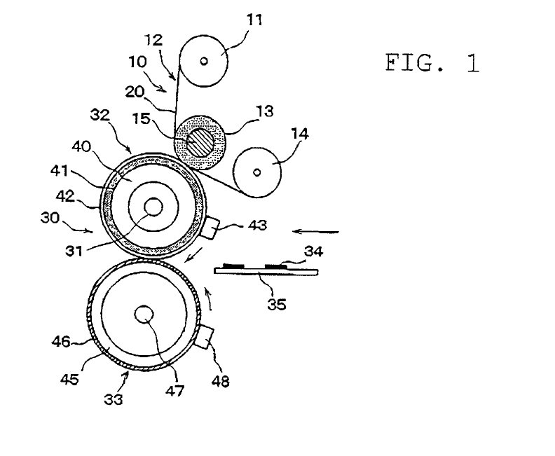

An embodiment of the invention will now be described with reference to the drawing. FIG. 1 is a sectional view for illustrating the invention.

As shown, an oil application device 10 of the invention is provided in a fixing device 30 that will be described later. In the oil application device, the web 12 supplied frog a supply roll 11 is impregnated with the fuser oil, and the web 12 is pushed by a pushing roll 13 onto a fuser roller 30 and is taken up by a take-up roll 14. Then, the fuser oil is applied onto the fuser roller 30. The take-up speed may be about 5 to 30 mm a minute.

The pushing roll 13 (oil application roll) has a porous heat-resistant felt layer 16 formed on the surface of, for example, a metal core 15.

In the present invention, a silicone oil is used as a fuser oil, for example. In this case, the silicone oil has a viscosity of, usually, from 10 to 500,000 cSt and, preferably, from 50 to 500,000 cSt. In this specification, the viscosity stands for the one at 25° C. unless stated otherwise.

The silicone oil as a fuser oil is mixed with a curing agent, and the mixture of the silicone oil and the curing agent is applied to and impregnated with a paper made of a heat resistant fiber. In the present invention, a silicone varnish or a silicone rubber is used as the curing agent.

In this case, if a silicone oil is mixed with a silicone varnish, the silicone varnish is dispersed into the silicone oil of the mixture and is cured with being extremely swelled by the silicone oil. This phenomenon can be regarded as a state that the silicone oil is provided with fine porosity. As a result, oil-holding performance of the silicone oil is improved on the paper, and oozing and leaking of the silicone oil is restrained.

Further, in the case where a silicone oil is mixed with a silicone rubber, effects and advantages are similar to the case of silicone varnish. A silicone rubber exhibits some kinds of curing (crosslinking) reactions. Therefore, it is preferable that one of suitable kinds of the reactions is selected in accordance with a manufacturing method since the time necessary for the curing reaction can be drastically shortened. Further, a silicone rubber is advantageous in that it does not contain an organic solvent, which a silicone varnish contains.

As a silicone varnish, one generally called as a “silicone varnish” can be used. That is, in the present invention, a silicone varnish is obtained, for example, by dissolving the unreacted silicone resin into a solvent, such as toluene and Xylen. This kind of the silicone varnish contains much of a tri- to tetra-functional siloxane bond. A silicon varnish, which is a solution of silicone resin, exhibits superior adhering ability to the silicone rubber. The silicone varnish has a viscosity of, usually, from 10 to 200,000 cSt and, preferably, from 100 to 60,000 cSt.

Further, a silicone rubber is one generally called as a “liquid silicone rubber”. This kind of the silicone rubber is obtained by adding a reaction catalyst or a crosslinking agent into a linear colydimethylsiloxane or a copolymer thereof. The obtained rubber exhibits elasticity of rubber.

The ratio of blending the silicone oil and the curing agent in the mixture is, usually, from 10:90 to 95:5 and, preferably, from 50:50 to 90:10 on the weight basis.

The web 12 forms the gist of the invention and is constituted by the paper 20. In detail, the paper 20 is obtained in the form of a paper from the heat-resistant fiber and the binder. As the heat-resistant fiber used for the paper 20, there can be exemplified an aramid fiber, a polyester fiber and a ceramic fiber. Alternatively, it is also preferable to use a mixture including some of the above fibers or one kind, in which diameters of the fibers are different from each other, of the above fibers. Among them, the heat-resistant fiber which is the aramid fiber is desired from the standpoint of price, heat resistance and flexibility. It is further desired that the heat-resistant fiber used for the paper 20 is a short fiber from the standpoint of surface smoothness.

There is used the paper 20 that is very thin, highly dense, lowly gas permeable and is fine. In detail, the paper 20 has a thickness of, usually, from 30 to 1000 μm and a density of, usually, from 10 to 100 g/m². The paper 20 having properties lying within this range is desired from the standpoint of surface smoothness, flexibility, easy winding and a small step after the winding.

### EXAMPLES

The invention will be described more concretely by way of an example which, however, is simply to illustrate the invention but is not to limit the invention.

### Example 1

As the paper 20, there was prepared a paper of aramid fiber (Nomex Aramid Paper, manufactured by Du Pont Kabushiki Kaisha) having an average fiber diameter of 10 μm, an average fiber length of 30 μM processed to possess a thickness of 60 μm and a density of 0.6 g/m³, and having a predetermined width (320 mm). The aramid fiber paper was applied and impregnated with a mixture of a silicone varnish (Trade name “KR-105” manufactured by Shin-Etsu Chemical Co., Ltd.) having a viscosity at 25° C. of 1000 cSt and a silicone oil (Trade name “KF-96” manufactured by Shin-Etsu Chemical Co., Ltd.) having a viscosity at 25° C. of 300 cSt at a weight ratio of 40:60 at a surface density of 50 g/M². The obtained aramid fiber paper is heat-treated at 70° C. for five hours.

### Example 2

The aramid fiber paper 20, same as that of Example 1, was applied and impregnated with a mixture of a silicone rubber (Trade name “KR-2042” manufactured by Shin-Etsu Chemical Co., Ltd.) having a viscosity at 25° C. of 100 cSt and a silicone oil (Trade name “KF-96” manufactured by Shin-Etsu Chemical Co., Ltd.), same as that of Example 1, at a weight ratio of 20:80 at a surface density of 50 g/m². The obtained aramid fiber paper is heat-treated at 150° C. for 10 minutes.

Constitution of the fixing device 30 shown in FIG. 1 will now be described. This fixing device 30 contains a halogen lamp 31 therein, and the fuser roller 32 rotates in the direction of an arrow. A pressing roll 33 rotates in the direction of an arrow with being pressed onto the fuser roller 32. Upon passing through a recording paper 35 on which an unfixed toner image 34 is transferred between the fuser roller 32 and the pressing roll 33, the unfixed toner image 34 is fixed onto the recording paper 35 due to the heat and pressure.

A metal cylinder 40 of the fuser roller 32 is covered with an elastic layer 41, and a top coat layer 42 is formed on the surface thereof. Reference numeral 43 denotes a temperature sensor which works to maintain the surface of the fuser roller 32 at a predetermined temperature.

A parting layer 46 is formed on a metal cylinder 45 of the pressing roll 33, and a halogen lamp 47 is provided therein. Reference numeral 48 denotes a temperature sensor which works to maintain the surface of the pressing roll 33 at a predetermined temperature.

The oil is applied onto the fuser roller 30 in a manner as described below. First, the web 12 is delivered from the supply roll 11 with accompanying the turn of the fuser roller 30 and is, at the same time, taken up by the take-up roll 14. At this moment, the web 12 is pushed by the pushing roll 13 onto the fuser roller 30 whereby the silicone oil held in the web 12 is applied onto the surface of the fuser roller 30.

### Evaluation

An amount of oil application is measured in the case where a paper (web) is fed 5 mm in length when one sheet of an A4-size paper 35 is passed through a toner-fixing portion. The amount of oil application is 1.7 mg/sheet in the case of Example 1 and 2.8 mg/sheet in the case of Example 2. Accordingly, it can be said that a device and web according to the present invention exhibits the results equivalent to the case where a conventional oil application device provided with a PTFE porous film is used.

Application of this invention is not limited to the oil application device at the toner-fixing portion only but can be extensively used for the mechanisms for applying the fuser oil by using the web.

Being constituted as described above, the present invention exhibits the effects as described below.

(1) According to the first and second aspect of the invention, there can be cheaply constituted a web capable of controlling the application of an oil which includes a silicone oil and a curing agent without the need of using an expensive PTFE porous film, with satisfying a proper oil-holding performance, a strength and a parting property from the toner and capable of making it possible to realize the oil application device at a low cost.

(2) According to the third and fourth aspects of the invention, there can be cheaply constituted a web capable of controlling the application of an oil which includes a silicone oil and a curing agent without the need of using an expensive PTFE porous film, with satisfying a proper oil-holding performance, a strength and a parting property from the toner and capable of making it possible to realize the oil application web at a low cost.

What is claimed is:

1. An oil application device for applying and supplying fuser oil onto a fuser roller, comprising:
a web coming in contact with the surface of the fuser roller;
a supply roll for delivering the web; and
a take-up roll for taking up the web,
wherein the web is applied and impregnated with a mixture of a fuser oil and a curing agent by having a paper made of a heat-resistant fiber impregnated with the mixture.

2. The oil application device according to claim 1, wherein the fuser oil is a silicone oil, amid the curing agent is a silicone varnish.

3. The oil application device according to claim 1, wherein the fuser oil is a silicone oil, and the curing agent is a silicone rubber.

4. An oil application web for applying and supplying fuser oil,
wherein the web is applied and impregnated with a mixture of a fuser oil and a curing agent by having a paper made of a heat resistant fiber impregnated with the mixture.

5. The oil application web according to claim 4, wherein the fuser oil is a silicone oil, and the curing agent is a silicone varnish.

6. The oil application web according to claim 4, wherein the fuser oil is a silicone oil, and the curing agent is a silicone rubber.
